(19) United States
(12) Patent Application Publication
(10) Pub. No.: US 2019/0351736 A1
(43) Pub. Date: Nov. 21, 2019

(54) HVAC SYSTEM WITH SEPARABLE HEATER HOUSING

(71) Applicant: Calsonic Kansei North America, Inc., Farmington Hills, MI (US)

(72) Inventors: Silvia Denisse Vazquez Salazar, Farmington Hills, MI (US); Christopher Lynn Dawson, Farmington Hills, MI (US)

(21) Appl. No.: 15/985,439

(22) Filed: May 21, 2018

(51) Int. Cl. B60H 1/00

(52) U.S. Cl. CPC B60H 1/00542; B60H 2001/00107; B60H 1/00528; B60H 1/00535

(57) ABSTRACT

An HVAC system includes an evaporator housing having an evaporator disposed therein, and a heater housing having a heater disposed therein. The heater housing is configured to be removably coupled to and supported by the evaporator housing.

### BACKGROUND

The present application relates generally to the field of heating, ventilation, and air conditioning (“HVAC”) systems for vehicles, and more particularly to HVAC systems having modular components for quick assembly and disassembly.

A conventional HVAC system includes a single housing that contains various HVAC components, including a blower, a heater, and an evaporator. This housing may be formed from two shell components (e.g., halves). During assembly, the blower, heater, and evaporator are positioned within a first shell component, and a second shell component is mated with the first shell component, enclosing the blower, heater, and evaporator within the single housing.

In the conventional configuration, when one of the HVAC components is damaged and needs to be removed from the housing for either repair or replacement, the housing must be opened, revealing all of the HVAC components. Further, due to space constraints in vehicles, the entire HVAC system must be removed from the vehicle in order to access and remove the second shell component. However, in order to remove the HVAC system from the vehicle, the evaporator must be disconnected from air conditioning lines, which carry refrigerant between a condenser and the HVAC system. This extra process can be difficult and time-intensive, as well as result in loss of the refrigerant. Furthermore, the weight of the HVAC system may require an operator to use special machinery to remove the entire HVAC system from the vehicle.

It would therefore be advantageous to provide an HVAC system with separate modules for each of the blower, heater, and evaporator in order to improve maintenance access to the HVAC components, and particularly to be able to service the heater without disconnecting the condenser.

### SUMMARY

One embodiment relates to an HVAC system including an evaporator housing having an evaporator disposed therein, and a heater housing having a heater disposed therein. The heater housing is configured to be removably coupled to and supported by the evaporator housing.

Another embodiment relates to an HVAC system including an evaporator housing, a blower housing, and a heater housing pivotally coupled to at least one of the evaporator housing or the blower housing. The heater housing is separable from the evaporator housing and the blower housing.

Another embodiment relates to a method of assembling an HVAC system including providing an evaporator housing, a blower housing, and a heater housing. The method further includes pivotally coupling a the heater housing to the evaporator housing and coupling the heater housing to the blower housing in a fixed orientation relative to at least one of the blower housing or the evaporator housing.

### BRIEF DESCRIPTION OF THE DRAWINGS

FIG. 1 is an exploded view of an HVAC system according to an exemplary embodiment.

FIG. 2 is a close-up exploded view of a lower attachment mechanism for connecting a heater module to an evaporator module.

FIG. 3 is a close-up view of the lower attachment mechanism of FIG. 2 in an installed configuration.

FIG. 4 is a close-up exploded view of a lower attachment mechanism for connecting a heater module to an evaporator module according to another exemplary embodiment.

FIG. 5 is an elevation view of the HVAC system shown in FIG. 1, with the heater housing partially installed.

FIG. 6 is a close-up exploded view of an upper attachment mechanism for connecting a heater module to a blower module.

FIG. 7 is a close-up view of the upper attachment mechanism of FIG. 6 in an installed configuration.

### DETAILED DESCRIPTION

Referring to the FIGURES generally, an HVAC system 10 is shown according to an exemplary embodiment. The HVAC system 10 is a modular system and includes a separable evaporator module 12 (i.e., cooling module), a blower module 14, and a heater module 16. The heater module 16 is disposed in the HVAC system 10 downstream from both of the evaporator module 12 and the blower module 14 and is configured to distribute air from the HVAC system 10 to different portions of a vehicle.

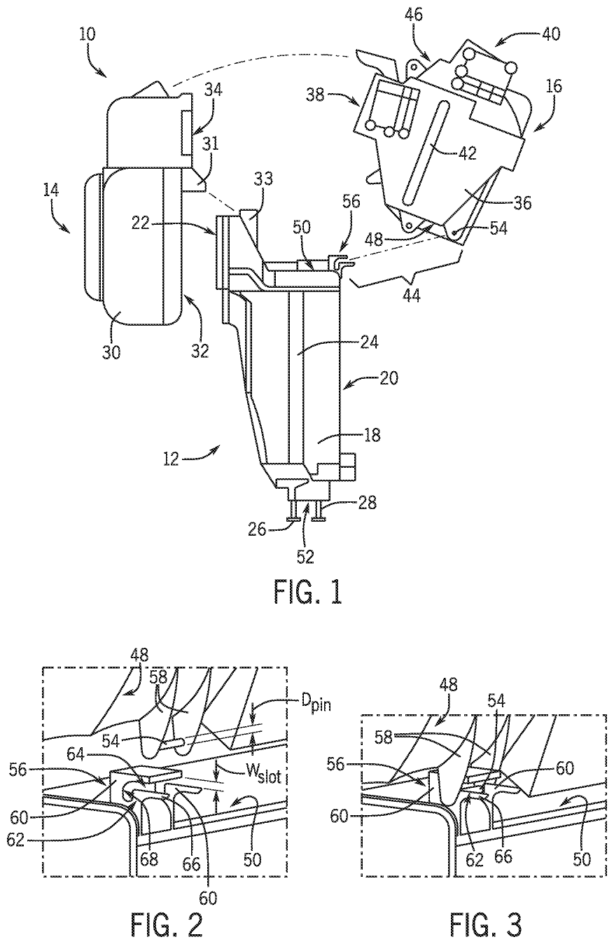

Referring now to FIG. 1, the HVAC system 10 is shown according to an exemplary embodiment. The evaporator module 12 includes an evaporator housing 18 (i.e., evaporator case) that includes an evaporator inlet 20 at an upstream end of the evaporator housing 18 and an evaporator outlet 22 at a downstream end of the evaporator housing 18. An evaporator 24 is disposed in the evaporator housing 18 between the evaporator inlet 20 and the evaporator outlet 22. Refrigerant passes through the evaporator 24 and is configured to remove heat from the ambient air passing through the evaporator 24. A condenser (not shown) is provided in another portion of the vehicle and is configured to condense heated refrigerant from the evaporator 24. For example, the evaporator module 12 includes a refrigerant supply line 26 fluidly connecting the condenser to the downstream evaporator 24 and a refrigerant return line 28 fluidly connecting the evaporator 24 to the downstream condenser.

During operation of the HVAC system 10, ambient air is supplied to the evaporator module 12 through the evaporator inlet 20. Refrigerant flows from the condenser, through the refrigerant supply line 26, to the evaporator 24. As the ambient air passes through the evaporator 24, heat from the air is transferred through the evaporator 24 to the refrigerant, thereby lowering the temperature of the air in the evaporator module 12 (e.g., cooling the air). The heated refrigerant is then output from the evaporator 24, through the refrigerant return line 28, and returned to the condenser. In the condenser, the refrigerant is condensed and cooled before being recirculated to the evaporator 24 to absorb more heat to continue cooling the ambient air.

In this configuration, the condenser is installed in a vehicle at a location that is remote or spaced apart from the HVAC system 10. For example, the condenser may be installed proximate a radiator in order to assist in condensing and cooling the refrigerant. However, the evaporator module 12 may be disposed in another location of the vehicle, remotely relative to the condenser, such that the refrigerant supply line 26 and refrigerant return line 28 are required to carry the refrigerant over a distance between the evaporator 24 and the condenser. Leaks in the refrigerant lines 26, 28 may cause the evaporator module 12 to malfunction because insufficient refrigerant is available to transfer the desired quantity of heat. Refrigerant may be lost from the HVAC system 10 during servicing when the refrigerant lines 26, 28 are disconnected. However, these refrigerant losses can be either minimized or prevented by servicing the HVAC system 10 without disconnecting the evaporator 24 from the condenser.

As shown in FIG. 1, the components (e.g., the evaporator module 12, the blower module 14, and the heater module 16) forming the HVAC system 10 are modular, meaning that the components are separable and can be decoupled (i.e., disassembled) and recoupled (i.e., reassembled). In this configuration, the refrigerant lines 26, 28 may remain permanently connected to both the evaporator 24 and the condenser, while the blower module 14 and/or the heater module 16 may each be separated from the evaporator module 12 to service the blower module 14 and the heater module 16 without having to disconnect the refrigerant lines 26, 28.

Referring still to FIG. 1, the blower module 14 includes a blower housing 30 defining a blower inlet 32 at an upstream end of the blower housing 30 (i.e., blower case) and a blower outlet 34 at a downstream end of the blower housing 30. A blower includes a blower motor (not shown) and fan cage (not shown) and is disposed in the blower housing 30 between the blower inlet 32 and the blower outlet 34. As the blower motor operates, it rotates the fan cage, which draws air from the blower inlet 32 and accelerates the air before outputting the air from the blower outlet 34. The volume flow rate of air output from the HVAC system 10 into a passenger compartment of a vehicle is controlled by the rotational speed of the blower.

During assembly of the HVAC system 10, the blower module 14 may be coupled to the evaporator module 12, such that the blower module 14 is downstream from the evaporator module 12. The blower inlet 32 is aligned with and directly coupled to the evaporator outlet 22. For example, a blower arm 31 may extend from the blower housing 30 proximate the blower inlet 32 and may be coupled to an evaporator bracket 33 extending from the evaporator housing 18 proximate the evaporator outlet 22. The blower arm 31 and the evaporator bracket 33 may be coupled with a fastener or in other ways, such that the blower housing 30 is removably coupled to and separable from the evaporator housing 18. While FIG. 1 shows the blower arm 31 extending form the blower housing 30 and the evaporator bracket 33 extending from the evaporator housing 18, it should be understood that the evaporator housing 18 may include an arm and the blower housing may include a bracket. According to other exemplary embodiments, the blower housing 30 may be coupled to the evaporator housing 18 in other ways.

When the blower housing 30 is installed on the evaporator housing 18, as the blower operates, a low-pressure region is formed in the blower housing 30 proximate the blower inlet 32, which draws higher-pressure air from the upstream evaporator module 12 into the blower housing 30. When the evaporator 24 is operating (e.g., in a cooling configuration), the blower module 14 receives cooled air from the evaporator module 12. However, when the evaporator 24 is not operating (e.g., in a heating configuration), the air output from the evaporator module 12 is at an ambient temperature when it is received at the blower module 14.

While FIG. 1 shows the blower module 14 located downstream from the evaporator module 12 and upstream from the heater module 16, it should be recognized that the modules 12, 14, 16 may be arranged in other orders. For example, the blower module 14 may be disposed upstream from both the heater module 16 and the evaporator module 12. According to other exemplary embodiments, the evaporator housing 18 and the blower housing 30 may be formed as a single (e.g., integrally-formed) housing, such that the evaporator 24 and the blower are disposed in a single shared housing. In this configuration, the heater module 16 remains separable from both the evaporator module 12 and the blower module 14 for separately servicing the heater module 16.

Referring still to FIG. 1, the heater module 16 includes a heater housing 36 (i.e., heater case) defining a heater inlet 38 at an upstream end of the heater housing 36 and a heater outlet 40 at a downstream end of the heater housing 36. A heater 42 is disposed in the heater housing 36 between the heater inlet 38 and the heater outlet 40. The heater 42 may be a Positive Temperature Coefficient (“PTC”) heater, which converts electricity into heat. The heater 42 may simply be connected to an electrical source to generate heat rather than drawing heat from an internal combustion engine. Advantageously, the PTC heater 42 can be easily disconnected from the electrical source in order to remove the heater module 16 from the HVAC system 10 for service.

In contrast, other heaters (e.g., in water-cooled cars) rely on passing a fluid between the engine and through a matrix in a mixing chamber to transfer heat from the fluid, through the matrix, to air for heating the air. Similar to the evaporator module 12, a conventional heater in a water-cooled system may be difficult to disconnect without leaking water or other heat-transfer fluid and potentially damaging the HVAC system 10. However, it should be understood that while FIG. 1 shows the heater 42 as a PTC heater, according to other exemplary embodiments, the heater 42 may include other types of heaters. In these configurations, the heater 42 may be configured to easily disconnect from the other portions of the vehicle, including refrigerant supply and return lines 26, 28. For example, at least one of the heater 42, refrigerant supply line 26 or refrigerant return line 28 includes a quick-release coupling, such that the refrigerant supply and return lines 26, 28 may be quickly connected to or disconnected from the heater 42, such that the heater module 16 may be removed from the HVAC system 10. In the quick-release configuration, the coupling may be configured to prevent the refrigerant from passing through the coupling and leaking out of the HVAC system 10 when the heater 42 is disconnected (i.e., decoupled) from the refrigerant supply and return lines 26, 28.

With respect to the heater 42 as shown in FIG. 1, a PTC heater 42 may be lighter than other types of heaters. The evaporator housing 18 and the blower housing 30 may be formed from plastic. Because the weight of the heater 42 is reduced, the evaporator housing 18 and the blower housing 30 are not required to support as much weight as in a configuration with a conventional water-cooled heater. As a result of the weight savings, the evaporator housing 18 and the blower housing 30 may be formed from thinner plastic and/or have fewer ribs and other support structures to strengthen the respective housings 18, 30. This configuration reduces the amount of material required to form the evaporator and blower housings 18, 30, thereby reducing the cost and complexity of forming the evaporator and blower housings 18, 30. Similarly, the amount of material forming the heater housing 36 may be reduced, thereby reducing the cost and complexity of forming the heater housing 36 as well as the overall weight of the heater module 16. The weight savings of both the PTC heater 42 itself and the heater housing 36 as well as the ease of disconnecting the PTC heater 42 from the rest of the HVAC system allow the heater module 16 to be more easily separable from the evaporator module 12 and the blower module 14.

According to an exemplary embodiment, the heater module 16 further operates as a distribution system, configured to separate the air output from the heater housing 36 into multiple output streams to be supplied to the passenger compartment of the vehicle. For example, the heater housing 36 may be subdivided into a plurality of adjacent compartments corresponding to separate zones in the vehicle. Each zone may include a mixing door and a portion of the heater 42, which is individually controllable to set the temperature in the given zone. Each zone may further include at least one mixing door. For example, each zone may include a bypass door, which is configured to bypass the heater 42 by directing air received at the heater inlet 38 directly to the heater outlet 40 without first passing the air through the heater 42. Similarly, the heater module 16 may further include a mixing door proximate the heater outlet 40 downstream from the heater 42 and the mixing door. The mixing door may partially or fully block the air flowing through the heater outlet 40 in order to specifically restrict the volume flow rate in any given zone. In this configuration, the mixing doors may articulate to provide a different flow rate at each zone, even though the blower module 14 supplies air with a uniform flow rate between all zones. It should be understood that according to other embodiments, the mixing doors may be disposed in other locations in the HVAC system 10 downstream from the blower.

The HVAC system 10 includes a lower (i.e., first) attachment mechanism 44 configured to couple the heater module 16 to the evaporator module 12. It should be noted that the heater module 16 includes a heater upper surface 46 and an opposing heater lower surface 48. The heater upper surface 46 is located at an upper portion of the heater housing 36, between the heater inlet 38 and the heater outlet 40. The heater lower surface 48 may be located at a substantially lowermost portion of the heater housing 36. The evaporator module 12 similarly includes an evaporator upper surface 50 and an opposing evaporator lower surface 52. The evaporator upper surface 50 is located at an upper portion of the evaporator housing 18 proximate the evaporator outlet 22. The lower attachment mechanism 44 includes a pin 54 (i.e., shaft, bar, rod, male member, etc.) configured to be slidingly received and retained in a corresponding hook 56, such that the heater lower surface 48 is pivotally coupled to the evaporator upper surface 50. The pin 54 is offset from (e.g., substantially parallel to) the heater lower surface 48. In this configuration, the pin 54 is formed proximate and below the heater lower surface 48. It should be understood that while FIG. 1 shows a lower attachment mechanism 44 having a pin 54 and hook 56 for coupling the heater housing 36 to the evaporator housing 30, according to other exemplary embodiments, the lower attachment mechanisms 44 may include other configurations, such that the heater housing 36 engages and is pivotally coupled to the evaporator housing 30 at the evaporator upper surface 50 or other surfaces of the evaporator housing 30.

Referring now to FIG. 2, a close-up exploded perspective view of the lower attachment mechanism 44 is shown according to an exemplary embodiment. As shown in FIG. 2, the pin 54 extends laterally between two opposing spaced-apart pin flanges 58, which extend substantially orthogonal to and away from the heater lower surface 48. The pin 54 has a substantially circular cross-section formed about a pin axis extending in the longitudinal direction (e.g., axially through the pin 54) and defines a pin diameter Dₚᵢₙ (i.e., a first diameter). According to other exemplary embodiment, the pin 54 may define other cross-sectional shapes or the cross-sectional shape may vary along a length of the pin 54. The pin 54 may be in a fixed orientation relative to the pin flanges 58 or may be configured to rotate freely about the pin axis while being held in place by the pin flanges 58. While FIG. 2 shows the lower attachment mechanism 44 having two pin flanges 58, according to other exemplary embodiments, the lower attachment mechanism 44 may include more or fewer pin flanges 58.

The hook 56 includes two opposing spaced-apart hook flanges 60, which extend substantially orthogonal to and away from the evaporator upper surface 50. It should be noted that while FIG. 2 shows the hook 56 having two hook flanges 60, according to other exemplary embodiments, the hook 56 may include more or fewer hook flanges 60. Each hook flange 60 defines a slot 62 (i.e., bearing, channel, etc.) formed therein, defining a first portion 64 (i.e., a first leg) extending into the hook flange 60 toward the evaporator outlet 22 and the blower module 14. The hook flange 60 further includes a ledge 66, which extends outward from the evaporator housing 30 (e.g., away from the evaporator outlet 22) and defines lower surface of the slot 62. The ledge 66 extends further out from the evaporator housing 30 than a corresponding upper surface of the slot 62. In this configuration, the ledge 66 provides a platform on which to rest the pin 54 when the heater module 16 is first disposed on the evaporator module 12. The ledge 66 supports the weight of the heater module 16 while an installer aligns the pin 54 with the slot 62.

A second portion 68 of the slot 62 extends from an end of the first portion 64 opposing the ledge 66. The second portion 68 (i.e., second leg) of the slot 62 extends in a different direction from the first portion 64 of the slot 62 planar within the hook flange 60. For example, the slot 62 may define an “L” shaped configuration, such that the first portion 64 extends in the hook flange 60 in a lateral direction (e.g., toward the blower module 14) and the second portion 68 extends in a vertical direction (e.g., downward from the evaporator upper surface 50 toward the evaporator lower surface 52).

Referring now to FIG. 3, the heater module 16 is shown being installed on the evaporator module 12 with the lower attachment mechanism 44. When the heater module 16 is positioned proximate the evaporator module 12, the heater housing 36 is oriented, such that the pin flanges 58 are substantially parallel to the hook flanges 60. In this configuration, the pin 54 is oriented substantially orthogonally to the hook flanges 60 and aligned with the slot 62. The heater module 16 is then slid along the ledge 66 from the first portion 64 to the second portion 68 as the heater module 16 is moved in a first direction toward the blower module 14. Once the pin 54 is reaches the end of the first portion 64 of the slot 62 and is received in the second portion 68, the pin 54 is moved in a second direction (e.g., the direction of the second portion 68, the downward direction), which is different from the first direction. Once the pin 54 is fully inserted into the second portion 68 of the slot 62, it cannot be moved in the lateral (e.g., first) direction without first repositioning the pin 54 in the slot 62. For example, according to an exemplary embodiment, the second portion 68 is in a substantially downward direction, such that the weight of the heater module 16 biases the pin 54 toward an end 70 of the slot 62 and prevents the pin 54 from disengaging the slot 62 without applying a force in the upward direction to overcome the weight and move the pin 54 from the second portion 68 of the slot 62 back to the first portion 64 of the slot 62.

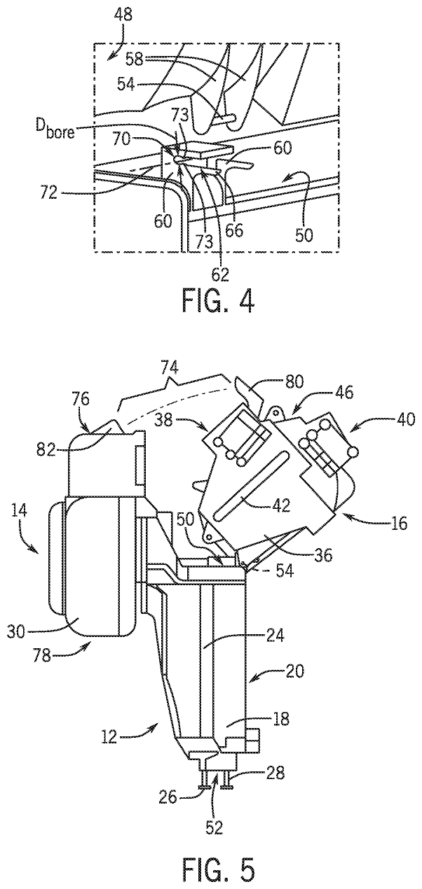

According to another exemplary embodiment, the pin 54 may be retained within the slot 62 in other ways. For example, referring now to FIG. 4, the pin 54 may be retained in the slot 62 with an interference fit. The slot 62 may define a substantially constant slot width Wₛₗₒₜ that is substantially the same as or greater than the pin diameter Dₚᵢₙ, such that the pin 54 may be passed easily through the slot 62 without interference. The end 70 of the slot 62 defines a bore 71, having a longitudinal axis 72, which extends through the ends 70 of each of the slots 62 in the lower attachment mechanism 44. The bore 71 defines a bore diameter D_{bore}, which is substantially the same as or greater than the pin diameter Dₚᵢₙ. A portion of the slot 62 defining the bore 71 may include a tapered region 73, where the slot width Wₛₗₒₜ decreases to be less than the pin diameter Dₚᵢₙ proximate the end 70 of the slot 62. In this configuration, as the pin 54 passes through the tapered region 73, the plastic material forming one or both of the pin 54 and the hook flange 60, such that the slot width Wₛₗₒₜ is temporarily the same as the pin diameter Dₚᵢₙ. The pin 54 then passes through the tapered region 73 and the pin 54 and/or the hook flange 60 returns to their natural states, such that the slot width Wₛₗₒₜ is less than the pin diameter Dₚᵢₙ. In this configuration, the pin 54 is retained proximate the end 70 of the slot 62 with an interference fit, preventing the pin 54 from being withdrawn from the slot 62. It should be noted that while FIG. 4 shows a substantially linear slot 62, according to other exemplary embodiments, the bore 71 may be disposed at an end of the second portion 68 of the slot 62 as shown in FIGS. 2 and 3.

The heater module 16 may be disconnected from the evaporator module 12 by reversing the assembly process. Specifically, a force is applied to the pin 54, which causes at least one of the pin 54 or the hook flange 60 to temporarily deform, such that the pin 54 may pass through the tapered region 73 and be withdrawn from the slot 62. According to another exemplary embodiment, the pin 54 may be separable from the pin flange 58, such that the pin 54 is received in a corresponding pin bore in the pin flanges 58 and is passed through the bore in the end 70 of the slot 62 when the slot is axially aligned with the pin bore.

In each of the configurations described, when the heater module 16 is installed on the evaporator module 12, the pin 54 is disposed along the longitudinal axis 72. In this configuration, the heater housing 36 is configured to rotate relative to the evaporator housing 18 about the longitudinal axis 72.

It should be understood that while FIGS. 1-3 show the lower attachment mechanism 44 having the pin 54 formed on the heater lower surface 48 and the hook 56 formed on the evaporator upper surface 50, the pin 54 and the hook 56 may be formed on other parts of the heater housing 36 and/or the evaporator housing 18, respectively. According to other exemplary embodiments, the pin 54 may be formed on the evaporator housing 18 (e.g., extending from the evaporator upper surface 50) and the hook 56 may be formed on the heater housing 36 (e.g., extending from the heater lower surface 48, such that the heater module 16 is pivotally coupled to the evaporator module 12. According to yet another exemplary embodiment, a portion of the blower module 14 may extend over the evaporator module 12 proximate the heater lower surface 48, such that the heater module 16 may be pivotally coupled to the blower module 14 instead of and in substantially the same way as how the heater module 16 is described being coupled to the evaporator module 12.

Referring now to FIG. 5, the HVAC system 10 is shown with the blower module 14 coupled to the evaporator module 12 and the heater module 16 partially installed in the HVAC system 10. Specifically, FIG. 5 shows the heater module 16 coupled to the evaporator module with the pin 54 received in the slot 62. In this configuration, the heater housing 36 is configured to rotate about the pin 54 at the longitudinal axis 72 until the heater housing 36 is disposed against and engages the blower housing 30 in an assembled position. When the heater housing 36 is disposed against the blower housing 30, the heater inlet 38 is substantially aligned with the blower outlet 34. For example, the heater inlet 38 may define substantially the same profile shape as the blower outlet 34. A gasket (not shown) may be disposed at an outer periphery of the heater inlet 38 and/or the blower outlet 34 to sealingly engage the connection therebetween and prevent air from leaking out of the HVAC system 10.

As shown in FIG. 5, the HVAC system 10 further includes an upper (i.e., second) attachment mechanism 74 configured to couple the heater module 16 to the blower module 14. The blower module 14 defines a blower upper surface 76 and an opposing blower lower surface 78. The blower upper surface 76 is defined at an upper portion of the blower housing 30 proximate the blower outlet 34. The blower lower surface 78 may be defined at a substantially lowermost portion of the blower housing 30. The upper attachment mechanism 74 includes an arm 80 extending from (i.e., disposed on) the heater upper surface 46 and a corresponding bracket 82 (i.e., brace, flange, etc.) extending from (i.e., disposed on) the blower upper surface 76. The arm 80 is coupled to the bracket 82, such that the heater module 16 is coupled to the evaporator module 12 and the blower module 14 in a fixed orientation.

It should be understood that while FIG. 5 shows the arm 80 extending from the heater upper surface 46, the arm 80 may extend from other surfaces (e.g., sides) of the heater housing 36. Similarly, while FIG. 5 shows the bracket 82 extending from the blower upper surface 76, the bracket 82 may extend from other surfaces (e.g., sides) of the blower housing 30, such that when the heater housing 36 is disposed against the blower housing 30, the arm 80 and the bracket 82 are aligned and configured to be coupled. While FIG. 5 shows the upper attachment mechanism 74 having one arm 80 and one bracket 82, according to other exemplary embodiments, the upper attachment mechanism 74 may include more arms 80 and/or brackets 82 on any of the described surfaces.

According to yet another exemplary embodiment, the arm 80 and the bracket 82 may be switched, such that the arm 80 extends from the blower housing 30 and the bracket 82 extends from the heater housing 36. Furthermore, the upper attachment mechanism 74 may instead or additionally couple the heater housing 36 to the evaporator housing 18, such that one of the arm 80 or the bracket 82 extends from the evaporator housing 18 (e.g., at the evaporator upper surface 50) and the other one of the arm 80 or the bracket 82 extends from the heater housing 36. In this configuration, the coupling between the heater housing 36 and the evaporator housing 18 holds the heater housing 36 in a fixed orientation relative to the evaporator housing 18 and/or the blower housing 30.

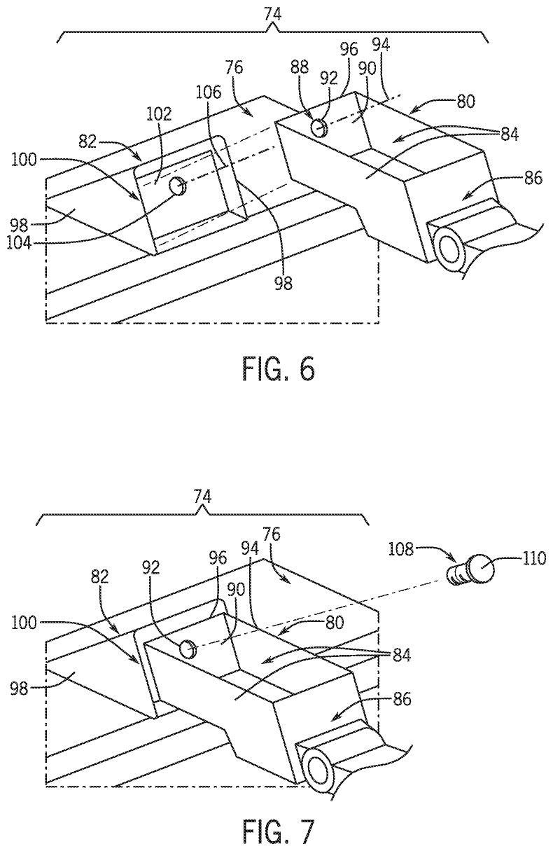

Referring now to FIG. 6, the upper attachment mechanism 74 is shown according to an exemplary embodiment. The arm 80 includes two opposing spaced-apart arm flanges 84 having a first end 86 at the heater upper surface 46 and an opposing second end 88 extending away from the heater housing 36. The arm flanges 84 are substantially planar and are formed substantially orthogonal to the longitudinal axis 72. An arm cross-member 90 is disposed at the second end 88 of the arm 80 and defines an arm bore 92 having an arm bore axis 94. The arm cross-member 90 may be formed at an oblique angle (e.g., between approximately 15 degrees and 75 degrees) relative to an upper edge 96 of the arm flanges 84. In this configuration, the arm bore axis 94 also defines an corresponding oblique angle, providing space for a tool (e.g., a screwdriver) to access the arm bore 92, even if the arm flanges 84 are spaced apart a distance smaller than a width of a tool's handle. This angled configuration improves access to the arm bore 92 and simplifies the tooling required to couple the arm 80 to the bracket 82.

Referring still to FIG. 6, the bracket 82 includes two opposing spaced-apart bracket flanges 98 at the blower upper surface 76 and having a forward edge 100 facing the arm 80. A bracket cross-member 102 extends between the bracket flanges 98 and is formed at an oblique angle relative to the blower upper surface 76. The bracket cross-member 102 is substantially parallel to the arm cross-member 90 when the heater housing 36 is in an installed position, disposed against the blower housing 30. As shown in FIG. 6, the bracket cross-member 102 defines a bracket bore 104 having a bracket bore axis 106.

Referring now to FIG. 7, the upper attachment mechanism 74 is shown in an installed configuration. Specifically, when the heater housing 36 is rotated about the longitudinal axis 72 until the heater housing 36 engages the blower housing 30, the arm cross-member 90 is disposed against the bracket cross-member 102, such that the arm bore axis 94 is substantially aligned (e.g., collinear) with the bracket bore axis 106. In the configuration shown in FIG. 7, the bracket bore 104 is threaded and a fastener 108 (e.g., a screw, bolt, etc.) having a fastener head 110 is fed through the arm bore 92 and into the bracket bore 104. The fastener 108 is then threadably coupled to the arm bore 92 and the heater housing 36 is positioned in a fixed rotational orientation by securing the arm cross-member 90 in place between the bracket cross-member 102 and the fastener head 110. According to another exemplary embodiment, the fastener 108 may be a bolt that passes through both the arm bore 92 and the bracket bore 104 and is threadably coupled to a nut or other structure, such that the arm cross-member 90 is secured against the bracket cross-member 102.

Advantageously, the combination of the lower attachment mechanism 44 with a single pivot point about the pin 54 and the upper attachment mechanism 74 with a single fastener 108 minimizes the complexity of installing the heater module 16 in the HVAC system 10. Specifically, tooling is only required to assemble the upper attachment mechanism 74, which expedites assembly and installation of the HVAC system 10 in a vehicle. Similarly, the heater module 16 may be easily removed from the HVAC system 10 for maintenance or repair by removing the fastener 108 and sliding the pin 54 out from the slot 62, while the evaporator module 12 and the blower module 14 remain installed in the vehicle.

It should be understood that while FIGS. 1-7 show the HVAC system 10 having a lower attachment mechanism 44 that pivotally couples the heater housing 36 to the evaporator housing 18 and the upper attachment mechanism 74 secures the heater housing 36 to the blower housing 30 in a fixed rotational orientation, according to other exemplary embodiments, the heater housing 36 may be configured to pivot relative to other components of the HVAC system 10 in other ways. For example, the heater housing 36 may be pivotally coupled to the blower housing 30 with the lower attachment mechanism 44 (e.g., with a pin 54 and hook 56) and the heater housing 36 may be coupled to the evaporator housing 18 in a fixed rotation orientation with the upper attachment mechanism 74 (e.g., with the arm 80 and the bracket 82).

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of this disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another. As described above, the terms “removably coupled” or “separable” indicate that two or more members may be assembled and subsequently disassembled without permanently modifying or damaging the members.

References herein to the position of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is to be understood that although the present invention has been described with regard to preferred embodiments thereof, various other embodiments and variants may occur to those skilled in the art, which are within the scope and spirit of the invention, and such other embodiments and variants are intended to be covered by corresponding claims. Those skilled in the art will readily appreciate that many modifications are possible (e.g., variations in sizes, structures, shapes and proportions of the various elements, mounting arrangements, use of materials, orientations, etc.) without materially departing from the novel teachings and advantages of the subject matter described herein. For example, the order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed is:

1. An HVAC system comprising:
an evaporator housing having an evaporator disposed therein; and
a heater housing having a heater disposed therein;
wherein the heater housing is configured to be removably coupled to and supported by the evaporator housing.

2. The HVAC system of claim 1, wherein the heater housing is pivotally coupled to the evaporator housing.

3. The HVAC system of claim 2, further comprising:
a pin formed on a lower surface of the heater housing; and
a slot formed on an upper surface of the evaporator housing;
wherein the pin is disposed in the slot.

4. The HVAC system of claim 3, wherein the heater housing is configured to rotate relative to the evaporator housing about the pin.

5. The HVAC system of claim 1, wherein the heater is a PTC heater.

6. The HVAC system of claim 1, further comprising a blower housing removably coupled to the evaporator housing and the blower housing.

7. An HVAC system comprising:
an evaporator housing;
a blower housing; and
a heater housing pivotally coupled to at least one of the evaporator housing or the blower housing;
wherein the heater housing is removably separable from the evaporator housing and the blower housing.

8. The HVAC system of claim 7, wherein the heater housing is coupled to at least one of the evaporator housing or the blower housing in a fixed orientation.

9. The HVAC system of claim 7, wherein the blower housing is separable from the evaporator housing.

10. The HVAC system of claim 7, further comprising a lower attachment mechanism comprising:
a pin extending from one of the heater housing or the evaporator housing; and
a hook extending from the other of the heater housing or the evaporator housing, the hook defining a slot configured to receive the pin therein.

11. The HVAC system of claim 10, wherein the pin extends from the heater housing and the hook extends from the evaporator housing.

12. The HVAC system of claim 10, wherein the pin is retained in the slot with an interference fit.

13. The HVAC system of claim 10, wherein:
the slot defines a first portion extending in a first direction and a second portion extending in a second direction different than the first direction;
the pin is configured to be inserted into first portion of the slot; and
the pin is configured to be secured in the second portion of the slot when the heater housing is coupled to the blower housing.

14. The HVAC system of claim 7, further comprising an upper attachment mechanism comprising:
a bracket extending from one of the blower housing or the heater housing; and
an arm extending from the other of the blower housing or the heater housing, the arm configured to be coupled to the bracket.

15. The HVAC system of claim 14, wherein the bracket extends from the blower housing and the arm extends from the heater housing.

16. The HVAC system of claim 14, wherein:
the arm defines an arm bore having an arm bore axis;
the bracket defines a bracket bore having a bracket bore axis;
the arm bore axis is substantially aligned with the bracket bore axis when the arm is disposed against the bracket; and
a fastener extends through the arm bore into the bracket bore for coupling the arm to the bracket.

17. The HVAC system of claim 14, further comprising:
a blower outlet defined by the blower housing; and
a heater inlet defined by the heater housing;
wherein the heater inlet is disposed on the blower outlet when the arm is disposed against the bracket.

18. A method of assembling an HVAC system comprising:
providing an evaporator housing, a blower housing, and a heater housing;
pivotally coupling a the heater housing to the evaporator housing; and
coupling the heater housing to the blower housing in a fixed orientation relative to at least one of the blower housing or the evaporator housing.

19. The method of claim 18, further comprising:
inserting a pin extending from a heater housing into a slot defined by an evaporator housing;
moving the evaporator housing toward a blower housing, such that the pin moves in the slot toward the blower housing;
rotating the heater housing radially about the pin until a heater inlet defined in the heater housing is aligned with and disposed on a blower outlet defined in the blower housing.

20. The method of claim 19, further comprising retaining the pin in the slot with an interference fit.
